(19) United States
(12) Patent Application Publication
(10) Pub. No.: US 2024/0202214 A1
(43) Pub. Date: Jun. 20, 2024

(54) CLUSTERING NUMERICAL VALUES USING LOGARITHMIC BINNING

(71) Applicant: International Business Machines Corporation, Armonk, NY (US)

(72) Inventor: Rajesh Bordawekar, Westchester, NY (US)

(21) Appl. No.: 18/067,770

(22) Filed: Dec. 19, 2022

(51) Int. Cl. G06F 16/28; G06F 16/242

(52) U.S. Cl. CPC G06F 16/285; G06F 16/2433

(57) ABSTRACT

Clustering data points of a relational database having special data types is performed by establishing logarithmic bins in which the data is collected. Special data types include (i) zero; (ii) positive and negative values; (iii) infinity (positive and negative); (iv) not-a-number values (NaNs); (v) out-of-range values; and (vi) IEEE DECFloat (decimal floating-point) values. The numerical data is mapped to bins according to their values and redistributed among the bins based on median bin value. An occupancy-based partitioning process assures each bin has no more than a pre-defined threshold percentage of the data. Assigning data bins to clusters facilitates prediction of placement of input values into a particular cluster for response to database queries.

### STATEMENT ON PRIOR DISCLOSURES BY AN INVENTOR

The following disclosure(s) are submitted under 35 U.S.C. 102(b)(1)(A) as prior disclosures by, or on behalf of, a sole inventor of the present application or a joint inventor of the present application:
(i) “base10Cluster,” Z/OS/2.5.0, 2022 Jun. 29; and
(ii) “Running AI queries with SQL Data Insights,” Db2 for z/OS/13, 2022 Aug. 2.

### BACKGROUND

The present invention relates generally to the field of relational databases, and more particularly to AI-based SQL queries of relational databases.

Databases powered by artificial intelligence (AI) may use semantic word vector representations of relational entities to enable new kinds of structured query language (SQL) semantic queries. These databases may apply deep learning to SQL-based semantic queries on tables and views.

Parallel processing is a method in computing of running two or more processors (CPUs) to handle separate parts of an overall task. Breaking up different parts of a task among multiple processors operates to reduce the amount of time to run a program. Parallelization provides for concurrent tasks to be running on different computing nodes, often depending on the type of data structure or library in use.

### SUMMARY

In one aspect of the present invention, a method, a computer program product, and a system includes: mapping numerical data points from a dataset into a plurality of buckets organized using logarithmic ranges; redistributing the numerical data points among the plurality of buckets based on median values of the data points within each bucket; and partitioning the plurality of buckets into a set of evenly occupied buckets such that each bucket occupancy is less than a pre-defined threshold value.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system; and

FIG. 4 is a diagram showing information that is generated by and/or helpful in understanding embodiments of the present invention.

### DETAILED DESCRIPTION

Clustering data points of a relational database having special data types is performed by establishing logarithmic bins in which the data is collected. Special data types include (i) zero; (ii) positive and negative values; (iii) infinity (positive and negative); (iv) not-a-number values (NaNs); (v) out-of-range values; and (vi) IEEE DECFloat (decimal floating-point) values. The numerical data is mapped to bins according to their values and redistributed among the bins based on median bin value. An occupancy-based partitioning process assures each bin has no more than a pre-defined threshold percentage of the data. Assigning data bins to clusters facilitates prediction of placement of input values into a particular cluster for response to database queries.

Some embodiments of the present invention facilitate leveraging of deep learning in AI (artificial intelligence) to extend the standard SQL (structured query language) to enhance the traditional data processing in a relational database. By clustering diverse numerical values in support of unsupervised learning neural network models are trained for discovering, matching, and grouping records with similarities, dis-similarities, and clusters. For example, some embodiments of the present invention facilitate learning from a large amount of training data having diverse types of numerical data including: (i) zero; (ii) positive and negative values; (iii) infinity (positive and negative); (iv) not-a-number values (NaNs); (v) out-of-range values; and (vi) IEEE DECFloat (decimal floating-point) values. Accordingly, AI-based SQL queries may be performed based on analogy, similarity, dissimilarity, and/or semantic clustering.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as clustering program 300. In addition to block 300, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 300, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

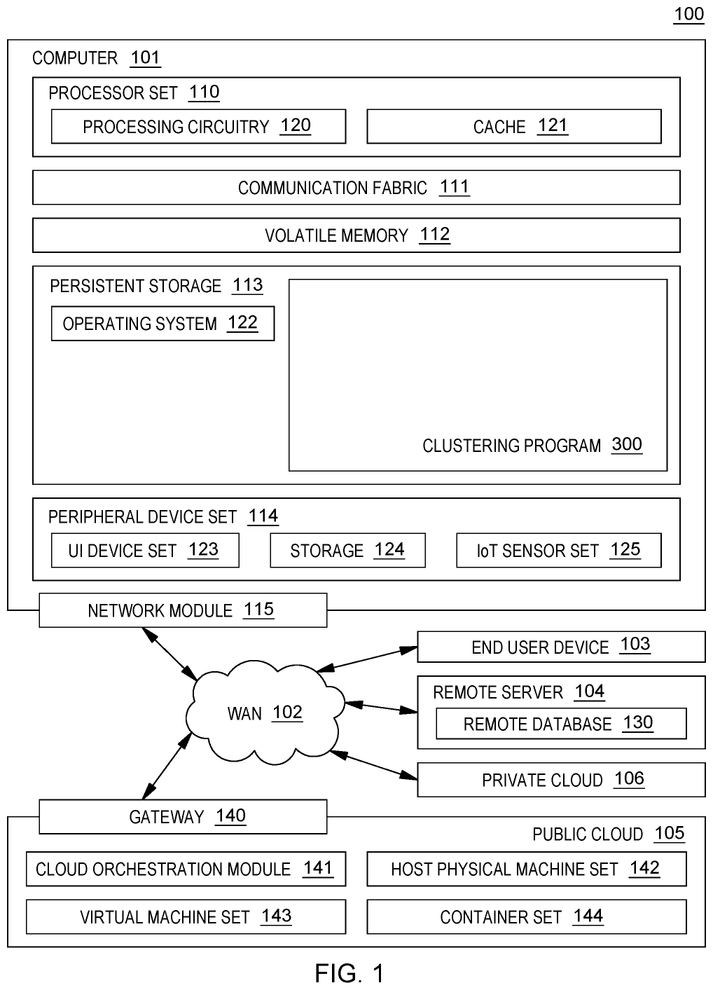

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 300 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 300 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Clustering program 300 operates to process numerical values, including special types of numerical values, into logarithmic bins or buckets for assignment to various identified clusters for which a semantic query may be performed. Input values are predicted to have a corresponding cluster of the identified clusters to facilitate responses to semantic SQL queries.

Some embodiments of the present invention recognize the following facts, potential problems and/or potential areas for improvement with respect to the current state of the art: (i) to support word vector representations, the numerical columns in the relational table are first clustered and then each numerical value is represented by a text token representing the cluster in which that numerical value lies (e.g. the value 100 belonging to cluster 1 may be represented by the text token “cluster1”); (ii) standard clustering libraries may be used including K-means versions; (iii) conventional clustering algorithms cannot handle data sets that include the value 0.0 or positive and negative values; (iv) conventional clustering algorithms cannot handle data sets that include the values infinity, not-a-number values (NaNs), out-of-range values, and IEEE DECFloat (decimal floating-point) values; (v) conventional clustering algorithms cannot efficiently support clustering of large datasets, such as a hundred million rows; (vii) conventional cost-based clustering methods such as K-Means are not able to properly cluster numeric values that include zero, NaNs, infinity, and positive/negative values; and (viii) existing cost-based approaches are computationally expensive.

Some embodiments of the present invention are directed to a clustering process having three phases: (i) binning; (ii) redistribution; and (iii) partitioning. The binning phase involves mapping the numerical data into multiple buckets organized using logarithmic ranges. All 0 values are mapped to a single bucket with 0 values. Further, there may be a special “EMPTY” bucket to contain special numerical data including: (i) positive and negative values; (ii) infinity (positive and negative); (iii) not-a-number values (NaNs); (iv) out-of-range values; and (v) IEEE DECFloat (decimal floating-point) values.

The redistribution phase involves using the median of each bucket to move items in different bins so that items with closer values are in the same bucket. For example, where 1.2 is in bucket (1,10) but is closer in value to 0.56, the median for bucket (0,1), than 7.2, the median for bucket (1,10), the value 1.2 would be redistributed to bucket (0,1).

The partitioning phase involves partitioning the buckets such that the occupancy of each bucket is less than a fixed limit, or occupancy limit (such as 30% or other percentage of total number of values in the dataset). The occupancy limit is independent of the input data distribution characteristics.

Parallelization is a performance optimization having increased importance when clustering for large datasets, such as those having tens or hundreds of millions of rows. Some embodiments of the present invention use parallel threads, each clustering a different dataset. Alternatively, some embodiments of the present invention use multiple threads to parallelize clustering of individual datasets.

Some embodiments of the present invention are directed to parallelization by intra-file parallelization, which involves implementing the binning phase using multiple threads where each thread processes a part of input data and populates its own set of bins. Alternatively, individual sets of bins are merged to generate a single set of bins that are then redistributed and partitioned.

Some embodiments of the present invention are directed to parallelization by inter-file parallelization where each file of the input data is assigned to a different set of processes and/or threads to partition the files in parallel. According to some embodiments of the present invention, parallelization may be implemented along with mini batching, which fetches a portion of the input data. In that way clusters may be built based on the fetched data portion (or mini-batch) and merge them with the existing clusters. This approach is similar to parallel execution, where each independent processing thread can work on different data portions to create multiple clusters, which are then merged together.

The prediction phase involves predicting cluster locations for every numerical value of the query. At runtime, the process refers to the minimum values of each cluster to assign the Cluster ID for a given numerical value. Once the Cluster ID is identified, it can be used for semantic queries. Essentially, the prediction process takes a given numerical value and identifies the corresponding cluster for that value. With each final cluster, the minimum value of the cluster is stored for reference. The following is an example algorithm for storing minimum values:

```
getClusterID(double input_val){
  For (i=2; i <= n; i++) { //(clusters are numbered 1 to clusters)
    if (input_val < minimum_of_cluster(i)){
      return i;
    }
  return n;
}
```

Some embodiments of the present invention are directed to a process for clustering that first uses a base 10 logarithm to partition the training data into fixed-sized bins and then uses cost-based methods to merge bins into clusters so that numerically closer items are in the same cluster, and the number of clusters are optimized based on user guidance, whether by maximum number of clusters or on a per cluster occupancy basis (percentage of data in the clusters).

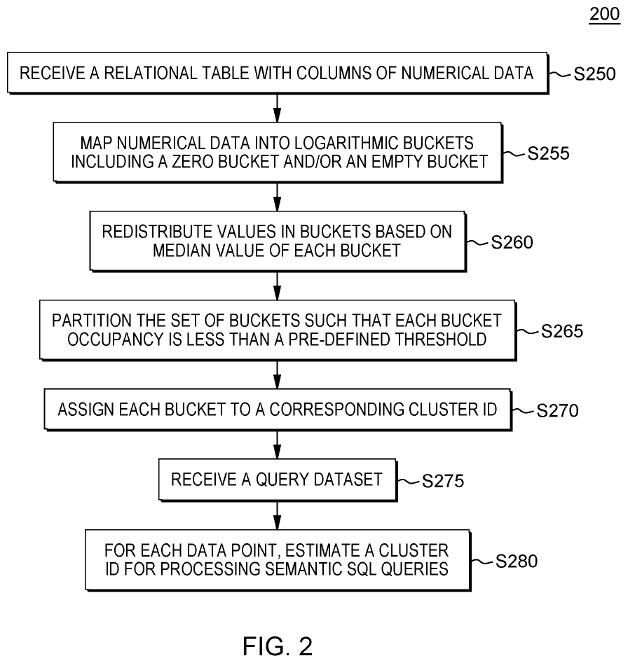

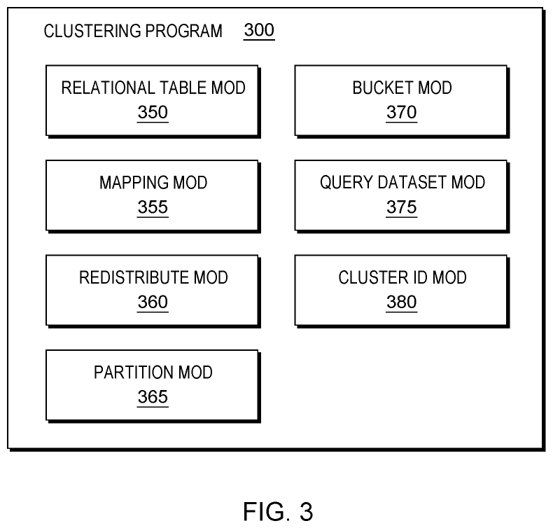

FIG. 2 shows flowchart 200 depicting a first method according to the present invention. FIG. 3 shows program 300 for performing at least some of the method steps of flowchart 200. This method and associated software will now be discussed, over the course of the following paragraphs, with extensive reference to FIG. 2 (for the method step blocks) and FIG. 3 (for the software blocks).

Processing begins at step S250, where relational table module (“mod”) 350 receives a relational table with columns of numerical data. In this example, the relation table is received by a grant of access to remote database 130 of remote server 104 (FIG. 1). Alternatively, the relational table is provided by a user. According to some embodiments of the present invention, the relational table is received for training and/or AI-based SQL queries. The table includes columns of numerical data having special types of values including: (i) zero; (ii) positive and negative values; (iii) infinity (positive and negative); (iv) not-a-number values (NaNs); (v) out-of-range values; and (vi) IEEE DECFloat (decimal floating-point) values.

Processing proceeds to step S255, where mapping mod 355 maps the numerical data into logarithmic buckets, or bins, including a zero bucket and/or an empty bucket. In this binning step, the columns of numerical data are processed by sorting the values into buckets, or bins, of data points, the buckets being organized using logarithmic ranges. Special types of values, or special data types, are handled with a zero bucket for zero values and an empty bucket for other data points such as infinity, both positive and negative, NaNs, out-of-range values, and (vi) DECFloat values.

According to some embodiments of the present invention, the clustering process of step S255 is performed by intra-file parallelization, where multiple threads are used, each thread processing a part of the input data (e.g. the received relational table with columns of numerical data). Each thread proceeds to populate its own set of buckets. These individual sets of buckets populated individually by the multiple threads are merged to generate a single set of buckets prior to redistribution in step S260, which follows.

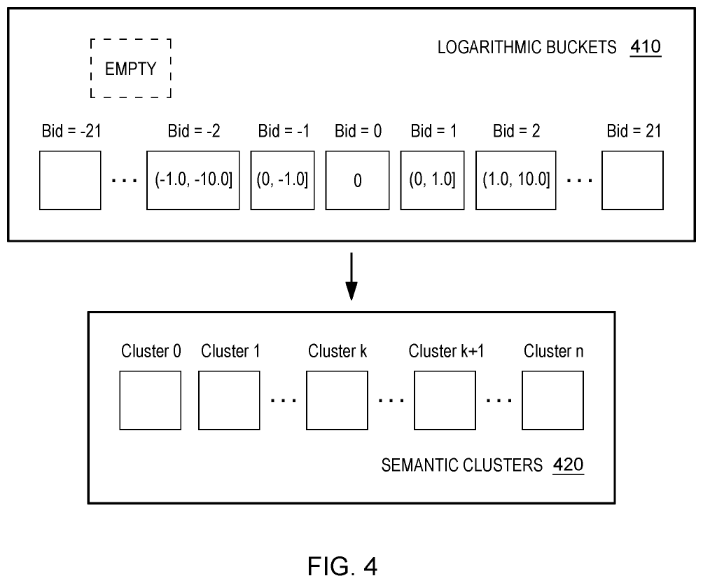

Processing proceeds to step S260, where redistribute mod 360 redistributes values in the buckets based on median value in each bucket. When the data points are sorted into the various buckets in step S255, the values are redistributed so that data points with closer, or more similar, values are in the same bucket. As shown in FIG. 4, discussed below, logarithmic buckets 410 include value ranges associated with each bucket. The set of buckets represent the range of data point values of the numerical value columns of the relational table.

Processing proceeds to step S265, where partition mod 365 partitions the set of buckets by occupancy such that each bucket occupancy is less than a pre-defined threshold value. In this example, each file of the relational table is assigned to a different set of processes, or threads, to partition the files in parallel. In that way, very large tables may be processes efficiently, for example tables having tens or hundreds of millions of rows.

Processing proceeds to step S270, where bucket mod 370 assigns each bucket to a corresponding cluster ID. In this example, the partitioned set of buckets are assigned cluster identifications in the set of semantic clusters 420 (FIG. 4). In an example process, the numbers are first assigned to buckets based on their base 10 log values. The buckets are then split or merged to clusters based on data characteristics and occupancy value. The final cluster values are stored in a file. Standard clustering libraries may be used when assigning corresponding cluster IDs to the partitioned set of buckets.

Processing proceeds to step S275, where query dataset mod 375 receives a query dataset.

Processing ends at step S280, where cluster mod 380, for each data point, estimates a cluster ID for processing semantic SQL queries.

Referring now to FIG. 4, example logarithmic buckets 410 are populated with numerical data from a target dataset. As discussed above, when the numerical data of the target dataset is redistributed and the buckets are partitioned according to an occupancy-based scheme, the buckets are assigned to semantic clusters 420 for response to semantic queries.

Some embodiments of the present invention are directed to clustering numeric values of different types using the logarithmic binning method. Some embodiments of the present invention are directed to generating balanced partitioning among clusters based on binning, value-based rebalancing, and occupancy-based partitioning. Some embodiments of the present invention are directed to clustering numerical data using multiple threads and mini batching to support very large datasets. Some embodiments of the present invention are directed to predicting the cluster ID of a numeric value using the minimum numeric value of each cluster in a set of corresponding clusters.

Some embodiments of the present invention are directed toward a method for clustering numerical values using logarithmic binning comprising: mapping data from a dataset into a plurality of buckets organized using logarithmic ranges; calculating and using a median of each bucket from the plurality of buckets to move data into different bins such that data with closer values are in a same bucket; and partitioning one or more buckets from the plurality of buckets such that each bucket occupancy is less than a fixed limit.

Some embodiments of the present invention are directed toward a method for clustering numerical values using logarithmic binning that includes: (i) using intra-file parallelization for the logarithmic binning by implementing a plurality of threads wherein each thread processes a part of input data and populates a set of bins; (ii) and merging individual sets of bins to generate a single set of bins, and redistributing and partitioning the single set of bins.

Some embodiments of the present invention are directed toward a method for clustering numerical values using logarithmic binning that includes using inter-file parallelization for the logarithmic binning by assigning files to a different set of threads to partition the files in parallel.

Some embodiments of the present invention are directed to performing clustering of numerical values using inter-file parallelization for logarithmic binning of the values in a large dataset. Some embodiments of the present invention assign files to different sets of threads to partition the files in parallel.

Some embodiments of the present invention may include one, or more, of the following features, characteristics and/or advantages: (i)) support semantic clustering on 0, positive, and negative values; (ii) supports different numeric value types supported by a database, including DECFloat (decimal floating-point) values; (iii) operates as a single-pass algorithm; and (iv) ability to parallelize, strip-mined (“mini-batch”) implementation.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or Cis true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method comprising:
mapping numerical data points from a dataset into a plurality of buckets organized using logarithmic ranges;
redistributing the numerical data points among the plurality of buckets based on median values of the data points within each bucket; and
partitioning the plurality of buckets into a set of evenly occupied buckets such that each bucket occupancy is less than a pre-defined threshold value.

2. The computer-implemented method of claim 1, further comprising:
calculating the median values of each bucket in the plurality of buckets.

3. The computer-implemented method of claim 1, wherein the pre-defined threshold value is a percentage of the total data points stored in the evenly occupied buckets.

4. The computer-implemented method of claim 1, wherein the mapping includes:
using intra-file parallelization by implementing a plurality of threads wherein each thread processes a part of the numerical data points and populates a respective set of buckets organized using logarithmic ranges; and
merging the respective sets of buckets to generate the plurality of buckets.

5. The computer-implemented method of claim 1, wherein the partitioning includes:
using inter-file parallelization by assigning each file of dataset to a different set of threads to partition the dataset in parallel.

6. The computer-implemented method of claim 1, further comprising:
receiving a query dataset including a first data point;
predicting the first data point to be within a first evenly occupied bucket; and
responding to the query based on the predicted first evenly occupied bucket.

7. A computer program product comprising a computer-readable storage medium having a set of instructions stored therein which, when executed by a processor, causes the processor to perform a method comprising:
mapping numerical data points from a dataset into a plurality of buckets organized using logarithmic ranges;
redistributing the numerical data points among the plurality of buckets based on median values of the data points within each bucket; and
partitioning the plurality of buckets into a set of evenly occupied buckets such that each bucket occupancy is less than a pre-defined threshold value.

8. The computer program product of claim 7, further comprising:
calculating the median values of each bucket in the plurality of buckets.

9. The computer program product of claim 7, wherein the pre-defined threshold value is a percentage of the total data points stored in the evenly occupied buckets.

10. The computer program product of claim 7, wherein the mapping includes:
using intra-file parallelization by implementing a plurality of threads wherein each thread processes a part of the numerical data points and populates a respective set of buckets organized using logarithmic ranges; and
merging the respective sets of buckets to generate the plurality of buckets.

11. The computer program product of claim 7, wherein the partitioning includes:
using inter-file parallelization by assigning each file of dataset to a different set of threads to partition the dataset in parallel.

12. The computer program product of claim 7, further comprising:
receiving a query dataset including a first data point;
predicting the first data point to be within a first evenly occupied bucket; and
responding to the query based on the predicted first evenly occupied bucket.

13. A computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to perform a method comprising:
mapping numerical data points from a dataset into a plurality of buckets organized using logarithmic ranges;
redistributing the numerical data points among the plurality of buckets based on median values of the data points within each bucket; and
partitioning the plurality of buckets into a set of evenly occupied buckets such that each bucket occupancy is less than a pre-defined threshold value.

14. The computer system of claim 13, further comprising:
calculating the median values of each bucket in the plurality of buckets.

15. The computer system of claim 13, wherein the pre-defined threshold value is a percentage of the total data points stored in the evenly occupied buckets.

16. The computer system of claim 13, wherein the mapping includes:
using intra-file parallelization by implementing a plurality of threads wherein each thread processes a part of the numerical data points and populates a respective set of buckets organized using logarithmic ranges; and
merging the respective sets of buckets to generate the plurality of buckets.

17. The computer system of claim 13, wherein the partitioning includes:
using inter-file parallelization by assigning each file of dataset to a different set of threads to partition the dataset in parallel.

18. The computer system of claim 13, further comprising:
receiving a query dataset including a first data point;
predicting the first data point to be within a first evenly occupied bucket; and
responding to the query based on the predicted first evenly occupied bucket.
